(19) United States
(12) Patent Application Publication
(10) Pub. No.: US 2006/0129907 A1
(43) Pub. Date: Jun. 15, 2006

(54) Syndicating multimedia information with RSS

(76) Inventors: Andrew R. Volk, San Francisco, CA (US); David D. Hall, New York, NY (US); John J. Thrall, San Francisco, CA (US)

Correspondence Address: GREENBERG TRAURIG, LLP, MET LIFE BUILDING, 200 PARK AVENUE, NEW YORK, NY, 10166, US

(21) Appl. No.: 11/291,401

(22) Filed: Dec. 1, 2005

Related U.S. Application Data
(60) Provisional application No. 60/633,295, filed on Dec. 3, 2004.

(51) Int. Cl. G06F 17/21

(52) U.S. Cl. 715/500

(57) ABSTRACT

System and method for adding descriptive information to a Real Simple Syndication (RSS) document. The descriptive information describes the content of media objects syndicated through the document. The descriptive information can be used to provided additional information to a subscriber, and can be used in searching for syndicated media content.

### CROSS-REFERENCE TO RELATED APPLICATIONS

This application claims the benefit of U.S. Provisional Application Ser. No. 60/633,295, filed Dec. 3, 2004, entitled SYSTEM AND METHOD FOR PROVIDING MULTIMEDIA FUNCTIONALITY WITH REALLY SIMPLE SYNDICATION, which is hereby incorporated herein by reference.

### FIELD OF THE INVENTION

This invention relates to the field of multimedia and the World Wide Web, and specifically to improve handling of the multimedia content utilizing Really Simple Syndication (RSS).

### BACKGROUND OF THE INVENTION

Really Simple Syndication, or RSS as it is known, is a dialect of the extensible markup language (XML) specification, which is used for providing content over the Internet and especially the World Wide Web. RSS permits the creation of documents and files in accordance with known parameters so that developers and publishers can readily produce content for access and retrieval over the World Wide Web in a simple manner.

RSS documents are elements within the XML language, which designates constituent portions as “elements.” RSS files or documents contain certain mandatory elements and certain optional elements. Thus, an RSS document is a <rss> element. Subordinate to the <rss> element is a single <channel> element, which contains information about the channel, namely metadata, and its contents. Subordinate elements are also known as subelements. Therefore, the <channel> element is a subelement of the <rss> element. The <channel> element has certain required elements and certain optional elements. Examples of required channel elements are the <title>, <link> and <description>. The <title> element is the name of the channel, which is how users having access to the channel would refer to the source of the particular RSS documents being published, typically a website. The <link> element is the actual URL to the website corresponding to the channel. The <description> element is a plain text phrase or sentence that describes the channel. Optional channel elements include the language that the channel is written in, an email address for a webmaster, a publication date, and others.

RSS also permits the inclusion of images as a subelement of <channel>. Another subelement of a channel is the <item > subelement. The <channel> may contain any number of <item> elements. An item may represent a story much like a story in a newspaper or magazine. An item may contain an <enclosure> subelement that can be used to associate one media object with an item. The <enclosure> subelement of <item> has three required attributes, namely URL, length and type. An example of an enclosure representation is indicated below:

<enclosure url=“http://www.scripting.com/mp3s/weatherReportSuite.mp3”
length=“12216320” type=“audio/mpeg” />

The enclosure element includes information that describes characteristics of the media object itself, such as, the length of the object and the type of the object, but the enclosure element does not include information that describes the user perceptible content of the media object, such as, the author of the weather report, or a text transcript of the weather report. Nor does the enclosure element include information related to the intellectual property rights associated with the media object.

A description of the media object's content can be included using a <description> subelement, but unfortunately, the description element is a non-specific element that can comprise unrelated data in no specific order. There is no standard for including information, such as, keywords, credits or text transcripts, in a description element, thus different RSS aggregators cannot render descriptive information about a media object consistently, and search engines and/or web crawlers cannot easily categorize and/or produce search results using the descriptive information. In addition, the <description> element can apply either to the <item> element or the <enclosure> element, and is therefore nondeterministic as to what the <description> element is describing. Accordingly, there is a desire, but no current solution, to syndicate media with additional descriptive information in a standard format, which describes the content of the media object with a greater level of specificity.

While a media object can be included with an item element using an <enclosure> element, unfortunately, each item element only supports one enclosure subelement. Therefore, if a media object is available in multiple video formats or multiple quality levels, a single item element cannot comprise all the available versions of the media object. A separate item element has to be created for each version. This makes it more difficult for aggregators to render multiple related media objects since each media object is under its own <item> and there is no standard for determining which <item> elements have related media objects. For example, all the films showed at a film festival cannot be grouped under a single item heading. Accordingly, there is a desire to syndicate multiple media objects under a single item element. Multiple media objects under a single item element allows syndicators to group related media objects for better organization, easier searchability and more efficient code.

In addition, while the <enclosure> element allows for the syndication of media objects, a URL providing a direct link to the media object must be provided. In some instances, a content provider may want to allow users to listen and/or view the content of the media object, but would like to limit the user's access to the media object itself. In other words, a content provider may want to allow a user to see and/or hear the content of a media object, but may not want the user to have access to a copy of the media object file that they can distribute. Therefore, there is a desire for methods and systems to limit a user's access to a media object itself in an RSS document.

### SUMMARY OF THE INVENTION

The invention as described and claimed herein satisfies this and other needs, which will be apparent from the teachings herein.

In one embodiment, an electronic document, such as, for example, a Real Simple Syndication (RSS) file comprises a first element written in a computer language, the language comprising a real simple syndication syntax, the element identifying a media object. The electronic document also comprises a second element, written in the computer language and parsable by a real simple syndication aggregator, the second element comprising, descriptive information, the descriptive information being related to the media object's content, and a predefined tag that identifies a predefined type of the descriptive information.

In one embodiment, the electronic document further comprises legal information that sets forth an intellectual property right associated with the media object.

In one embodiment, the descriptive information comprises a keyword that describes the media object's content. In one embodiment, the descriptive information identifies an image that describes the media object. In one embodiment, the descriptive information is a universal resource identifier that identifies an image associated with the media object. In one embodiment, the descriptive information comprises a taxonomy of the media object, wherein the taxonomy of the media object is used to categorize the media object. In one embodiment, the electronic document of claim 1, wherein the descriptive information comprises at least one entity that contributed to the creation of the media object. In one embodiment, the descriptive information comprises a text transcript of the words embodied in the media object. In one embodiment, the descriptive information comprises a bitrate. In one embodiment, the descriptive information comprises information identifying any one or more than one of an actor's role, a title, a cast, an artist, a director, a producer, a studio, a publisher, an album or a year associated with the media object.

In one embodiment, the first element identifies the media object via a universal resource identifier. In one embodiment, the second element identifies the media object via a universal resource identifier.

In one embodiment, the electronic document can further comprising a namespace declaration.

In one embodiment, a tag in the electronic document has a syntax comprising a less than symbol, a namespace, a colon, the predefined type and a greater than symbol. In one embodiment, the tag comprises the following syntax <media:content>. In one embodiment, the tag comprises the following syntax <media:category>. In one embodiment, the tag further comprises an attribute.

In one embodiment, the second element is a sub-element of the first element. In one embodiment, the first element is an enclosure element. In one embodiment, at least one of the first element and the second element further comprises at least one attribute, the attribute comprising the descriptive information.

In one embodiment, a computer application, comprises computer code defining at least one routine, the at least one routine being operable to render an electronic document, the electronic document comprising, a first element written in a computer language, the language comprising a real simple syndication syntax, the element identifying a media object; and a second element, written in the computer language and parsable by a real simple syndication aggregator, the second element comprising, descriptive information, the descriptive information being related to the media object's content, and a predefined tag that identifies a predefined type of the descriptive information.

In one embodiment, the second element of an electronic document rendered by the computer application further comprises legal information that sets forth an intellectual property right associated with the media object.

In one embodiment, the computer application is a real simple syndication aggregator. In one embodiment, the computer application is a browser.

In one embodiment, if a pointer is positioned over a rendered element, the computer application renders an additional user perceptible object. In one embodiment, the additional user perceptible object is a window overlaid over the rendered element, the window comprising the descriptive information.

In one embodiment, the computer application is an extension to a second computer application. In one embodiment, the extension is a media player plugin.

In one embodiment, a system for syndicating media comprises a syndicating computer, the syndicating computer being operable to transmit to a user computer an electronic document comprising, a first element written in a computer language, the language comprising a real simple syndication syntax, the element identifying a media object; and a second element, written in the computer language and parsable by a real simple syndication aggregator, the second element comprising, descriptive information, the descriptive information being related to the media object's content, and a predefined tag that identifies a predefined type of the descriptive information.

In one embodiment, the second element of the electronic document transmitted by the syndicating computer further comprises legal information that sets forth an intellectual property right associated with the media object.

In one embodiment, a method of syndicating media comprises, transmitting an electronic document to a computer, the electronic document comprising, a first element written in a computer language, the language comprising a real simple syndication syntax, the element identifying a media object; and a second element, written in the computer language and parsable by a real simple syndication aggregator, the second element comprising, descriptive information, the descriptive information being related to the media object's content, and a predefined tag that identifies a predefined type of the descriptive information.

In one embodiment, the second element of a transmitted electronic document further comprises legal information that sets forth an intellectual property right associated with the media object.

In one embodiment, the first element of a transmitted electronic document identifies the media object via a universal resource identifier, and the universal resource identifier further identifies a media player, the media player being operable to render the media object into a user perceptible form. In one embodiment, the method of syndicating media further comprises receiving at least some part of the universal resource identifier; and transmitting the media object to the media player.

In one embodiment, the descriptive information can be used in a search. In one embodiment, a method of searching media comprises searching descriptive information within an electronic document comprising, a first element written in a computer language, the language comprising a real simple syndication syntax, the element identifying a media object; and a second element, written in the computer language and parsable by a real simple syndication aggregator, the second element comprising, descriptive information, the descriptive information being related to the media object's content, and a predefined tag that identifies a predefined type of the descriptive information.

In one embodiment, the second element of a searched electronic document further comprises legal information that sets forth an intellectual property right associated with the media object.

In one embodiment, the method of searching media further comprises receiving a search request from a user, the search request comprising a search term; searching a database of electronic documents; and returning at least one search result to the user. In one embodiment, the at least one search result identifies a media object associated with a real simple syndication document. In one embodiment, search results are sorted based on the descriptive information.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates a personalized homepage comprising renderings of RSS feeds according to one embodiment of the invention.

FIG. 2 illustrates another personalized homepage comprising renderings of RSS feeds according to one embodiment of the invention.

FIG. 3 illustrates a system implemented according to an embodiment of the invention.

FIG. 4 illustrates a personalized homepage comprising renderings of RSS feeds according to one RSS module implemented in accordance with one embodiment of the invention.

and 5 illustrates a personalized homepage comprising renderings of RSS feeds according to one RSS module implemented in accordance with one embodiment of the invention.

FIG. 6 illustrates a search results page comprising search results obtained according to one embodiment of the invention.

FIG. 7 illustrates drop down menus that provide information related to topics on the search results page according to one embodiment of the invention.

### DETAILED DESCRIPTION OF EXEMPLARY EMBODIMENTS

There will now be shown and described in connection with the attached drawing figures several embodiments of a standard for delivering and describing media through a real simple syndication (RSS) scheme.

The term Internet as used herein, unless otherwise specified expressly or by context, is intended to have a broad non-limiting definition, and refers, without limitation, to a global computer network and any other group of computers communicatively coupled together.

The term server as used herein, unless otherwise specified expressly or by context, is intended to have a broad non-limiting definition, and refers, without limitation, to any computer or group of computers coupled to a computer network that stores network information and provides the network information to one or more other computers on the network.

In accordance with one embodiment of the invention, a novel RSS module that supplements the <enclosure> element capabilities of RSS 2.0 to allow more robust media syndication is described. The RSS module, which is labeled Media RSS, in one embodiment, comprises one or more new elements and/or attributes that allow for the specification of multimedia content with greater particularity and expands the ability of RSS to handle more complex tasks. This provides an improved user experience in dealing with RSS documents and files that are published with included multimedia objects.

In one embodiment, a single item of multimedia content can exist in different versions of encoded files, such as versions for applications compatible with Windows Media™ as provided by Microsoft, or content in Real™ format, provided by Real Networks Inc. Such files are encoded in different formats to be compatible with those different standards. Also, in addition to the version of encoding, the content may be deliverable at different speeds, thus for a particular item of multimedia content multiple different encoded files representing different formats and speeds would exist.

In one embodiment of the invention, the association of multiple encoded files can be combined in a single item of multimedia. Additionally or separately, in one embodiment, the new media elements and/or attributes allow for the ability to call a specific URL to be associated with a specific webpage or RSS publication document, the URL invoking, for example, a particular player with desired characteristics within the presented page, thus allowing the publisher of a particular item of content to more precisely control the user experience. Additionally or separately, in one embodiment, deeper layers of metadata can be associated with the RSS files thereby allowing publishers to greatly enrich the user experience as well as track and control information provided within RSS files or documents. This metadata may be indexed and made searchable by computer programs, such as for example by search engines, RSS readers, pod casters, search programs or websites, to enhance the ability of multimedia content to be searched for and located on the World Wide Web. A description of expanded multimedia RSS elements and/or attributes are described below.

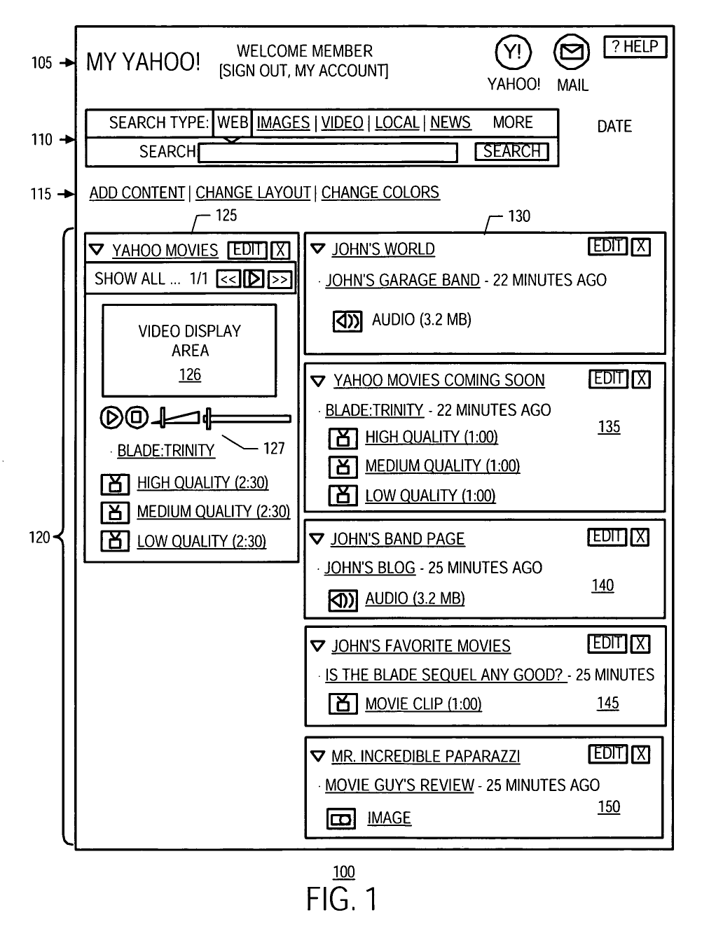

FIG. 1 illustrates a personalized homepage 100 implemented in accordance with one embodiment of the invention. The personalized homepage 100 comprises a title section 105, a search section 110, content controls 115 and a content display area 120. Information from a variety of web sources can be added to the content display area 120, using content controls 115. One type of information that can be added are RSS feeds. A personalized homepage 100 user can subscribe to one or more RSS feeds and the provider of the personalized homepage 100 can retrieve the user's feeds and render those feeds in the content display area 120.

Content display area comprises modules 125 through 150, which comprise rendered feeds. Some of the feeds are rendered from known RSS code and some of the feeds are rendered using one embodiment of Media RSS. The modules 125-150 are discussed below with the RSS code used to render the modules 125-150. All rendered feeds depicted herein represent an single interpretation of the underlying code. Other personalized homepages and/or aggregators can display the code in a plurality of ways. In addition, the embodiments of the invention are not limited to RSS aggregators in personalized homepages. Stand alone aggregators, and any other computer program that can render RSS feeds can be modified to accept Media RSS.

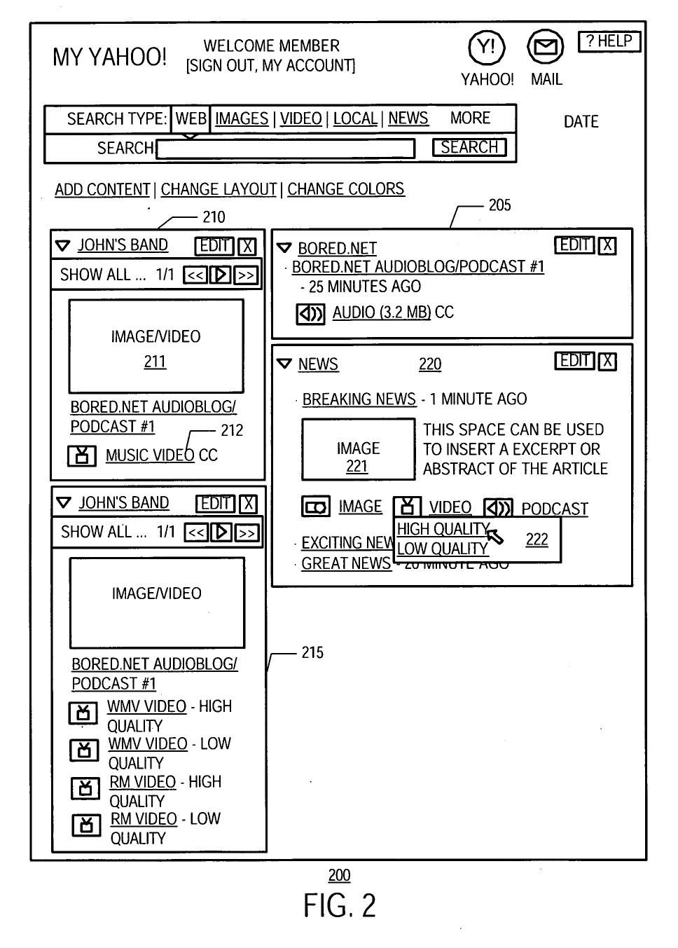

FIG. 2 illustrates another homepage 200 comprising additional modules discussed herein.

By way of example, a presently known RSS script is shown below:

```
<?xml version=“1.0” ?>
- <rss version=“2.0” xmlns:mrss=“http://docs.yahoo.com/mrssModule”>
  - <channel>
    <title>John's World</title>
    <link>http://www.fooblog.com</link>
    <language>en-us</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <managingEditor>editor@example.com</managingEditor>
    <webMaster>webmaster@example.com</webMaster>
  - <item>
      <title>John's garage band</title>
      <link>http://www.fooblog.com/karaoke.html</link>
      <description>My own interpretation of the national
        anthem</description>
      <pubDate>Tue, 30 Nov 2004 12:00:00 GMT</pubDate>
      <guid>http://www.fooblog.com/karaoke.html</guid>
      <enclosure url=“http://www.foo.com/anthem.mpg”
        length=“3200000” type=“video/mpeg” />
    </item>
  </channel>
</rss>
```

Module 130 of FIG. 1 illustrates one rendering of the sample code above. As is known in the art, only one media object can be associated with the item entitled “John's Garage Band.” In addition, as shown in the sample code above, the url attribute of the <enclosure> element provides a direct link to the media object, i.e., anthem.mpg. Furthermore, the known RSS code does not comprise deep layers of metadata that can further describe the content of the media object.

An example of a Media RSS script using the enhanced elements of one embodiment of the invention is shown below:

```
<?xml version=“1.0” ?>
- <rss version=“2.0” xmlns:mrss=“http://docs.yahoo.com/mrssModule”>
  - <channel>
    <title>Yahoo Movies Coming Soon</title>
    <link>http://movies.yahoo.com/movies/feature/
    comingsoon.html</link>
    <description>Upcoming movie releases.</description>
    <language>en-us</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <managingEditor>editor@example.com</managingEditor>
    <webMaster>webmaster@example.com</webMaster>
  - <item>
      <title>Blade: Trinity</title>
      <link>http://movies.yahoo.com/shop?d=hv&cf=info&id=1808
        473210&intl=us</link>
      <description>Movie trailer for Blade: Trinity on Yahoo!
        Movies.</description>
      <pubDate>Tue, 30 Nov 2004 12:00:00 GMT</pubDate>
      <guid>http://movies.yahoo.com/shop?d=hv&cf=info&id=1808
        473210&intl=us</guid>
    - <mrss:media>
        <mrss:playerLink>http://movies.yahoo.com/player.pl?id=1
          2345&quality=hi</mrss:playerLink>
        <mrss:mediaInfo height=“640” width=“400” duration=“150” />
        <mrss:mediaDefault />
      </mrss:media>
    - <mrss:media>
        <mrss:playerLink>http://movies.yahoo.com/player.pl?id=1
          2345&quality=mid</mrss:playerLink>
        <mrss:mediaInfo height=“480” width=“300” duration=“150” />
      </mrss:media>
    - <mrss:media>
        <mrss:playerLink>http://movies.yahoo.com/player.pl?id=1
          2345&quality=low</mrss:playerLink>
        <mrss:mediaInfo height=“320” width=“200” duration=“150” />
      </mrss:media>
      <mrss:thumbnail>http://img.yahoo.com/1231242.jpg</
      mrss:thumbnail
        >
      <mrss:movie title=“Blade: Trinity” cast=“Wesley Snipes, Kris
        Kristofferson, Ryan Reynolds, Jessica Biel, Parker Posey”
        year=“2004” contentType=“trailer” />
    </item>
  </channel>
</rss>
```

Module 125 of FIG. 1 illustrates one rendering of the sample code above. The <mrss:thumbnail> element provides a link to an image that can be displayed in video display area 126. In one embodiment, the image can be a frame from the video. Video controls 127 are positioned under the video display area 126 and the title of the item element is displayed under the video controls 127. The item comprises three video options high quality, medium quality and low quality, each displayed to a user as subelements of the “Blade:Trinity” title.

The sample script incorporates multiple versions of the described trailer, as well as player calls, enabling the display of a media file of desired resolution in a player of predetermined size, utilizing a single item element. In one embodiment, the desired resolution can be selected by the user. In one embodiment, a resolution can be automatically selected based upon automatic bandwidth detection techniques, such as those disclosed in U.S. Pat. No. 6,813,580 and U.S. Pat. No. 6,601,009, the disclosures of which are incorporated herein by reference.

The sample script also incorporates metadata that describes the media object and the content of the media object with greater detail than previously known. For example, were the metadata to be searched, the search result could return three results for the same media item, one for each resolution, for the user to select. Alternatively, the search can return one result, automatically selected by software or hardware or both, by detecting the bandwidth available to the user on the device they are using, and selecting the appropriate file based upon the detected bandwidth. The sample script also comprises a element that comprises the title of the movie, cast of the movie, the year the movie was released and type of the media content.

Another example is shown below:

```
<?xml version=“1.0” ?>
- <rss version=“2.0” xmlns:mrss=“http://docs.yahoo.com/mrssModule”>
  - <channel>
      <title>Yahoo Movies Coming Soon</title>
      <link>http://movies.yahoo.com/movies/feature/
      comingsoon.html</link>
      <description>Upcoming movie releases.</description>
      <language>en-us</language>
      <pubDate>Tue, 30 Nov 2004 12:00:00 GMT</pubDate>
      <lastBuildDate>Tue, 30 Nov 2004 12:00:00 GMT</lastBuildDate>
      <docs>http://blogs.law.harvard.edu/tech/rss</docs>
      <generator>Notepad</generator>
      <managingEditor>editor@example.com</managingEditor>
      <webMaster>webmaster@example.com</webMaster>
    - <item>
        <title>Blade: Trinity</title>
        <link>http://movies.yahoo.com/shop?d=hv&cf=info&id=1808
          473210&intl=us</link>
        <description>Movie trailer for Blade: Trinity on Yahoo!
          Movies.</description>
        <pubDate>Tue, 30 Nov 2004 12:00:00 GMT</pubDate>
        <guid>http://movies.yahoo.com/shop?d=hv&cf=info&id=1
        808473210&intl=us</guid>
    - <mrss:media>
          <mrss:mediaLink>http://movies.apple.com/movies/new
          line/blade_trinity/blade_trinity-
          tlr_640.mov</mrss:mediaLink>
        <mrss:mediaDefault />
      </mrss:media>
    - <mrss:media>
          <mrss:mediaLink>http://movies.apple.com/movies/new
          line/blade_trinity/blade_trinity-
          tlr_480.mov</mrss:mediaLink>
      </mrss:media>
    - <mrss:media>
          <mrss:mediaLink>http://movies.apple.com/movies/new
          line/blade_trinity/blade_trinity-
          tlr_320.mov</mrss:mediaLink>
      </mrss:media>
      <mrss:movie title=“Blade: Trinity” cast=“Wesley Snipes, Kris
        Kristofferson, Ryan Reynolds, Jessica Biel, Parker Posey”
        year=“2004” contentType=“trailer” />
    </item>
  </channel>
</rss>
```

Module 135 of FIG. 1 illustrates one rendering of the sample code above. The above example shows a single <item> element with multiple binary files embedded. In this example a user is given a direct link to the media object.

Internet content publishers have been using RSS to associate a media file (image, audio, video, flash, etc.) with other Internet content, such as, for example, a blog entry. Below is an example of an RSS document that couples a music file with a musician's blog:

```
<?xml version=“1.0” ?>
- <rss version=“2.0” xmlns:media=
“http://docs.yahoo.com/mediaModule”>
  - <channel>
    <title>John's Band Page</title>
    <link>http://www.fooblog.com</link>
    <language>en-us</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <managingEditor>editor@example.com</managingEditor>
    <webMaster>webmaster@example.com</webMaster>
  - <item>
      <title>John's garage band</title>
      <link>http://www.fooblog.com/karaoke.html</link>
      <description>My own interpretation of the national
      anthem</description>
      <pubDate>Tue, 30 Nov 2004 12:00:00 GMT</pubDate>
      <guid>http://www.fooblog.com/karaoke.html</guid>
      <enclosure url=“http://www.foo.com/anthem.mpg”
        length=“3200000” type=“video/mpeg” />
      </item>
  </channel>
</rss>
```

Module 140 of FIG. 1 illustrates one rendering of the sample code above.

Using one embodiment of Media RSS, structured metadata can be added to the known <item> element to further describe the media object and the content that is rendered by the media object. Therefore, in one embodiment, structured metadata can be added to the RSS code above that could further describe the song associated with the blog entry. For example, an additional Media RSS element describing the genre of the “anthem.mpg” song can be added to further describe the song. This additional information can be used in a number of ways. For example, in one embodiment, the song's genre information can help a search engine find the song on the Internet, thus making it more likely that the song is presented to an interested user as part of a search request from the user. Finding the song also leads to the interested user to the musician's blog, thereby provided the user with more desired information. In addition, in one embodiment, if an RSS feed comprises a number of songs from different genres, an aggregator can use the additional metadata to pick the songs a user enjoys.

In addition to blogs, other types of Internet media include, a text review about a movie, a news story, pictures related to a television show, and ID3 v1-like information about a song. Below is an example of an RSS feed for a movie reviewer's blog, which comprises an <enclosure> element and structured metadata describing the content of the media object referenced by the <enclosure> element:

```
<?xml version=“1.0” ?>
- <rss version=“2.0” xmlns:media=
“http://docs.yahoo.com/mediaModule”>
  - <channel>
    <title>John's Favorite Movies</title>
    <link>http://www.fooblog.com</link>
    <language>en-us</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <managingEditor>editor@example.com</managingEditor>
    <webMaster>webmaster@example.com</webMaster>
  - <item>
      <title>Blade: Is the sequel any good?</title>
      <link>http://www.fooblog.com/myreviews/blade.htm</link>
      <description>Just saw the Blade sequel the other
        day.</description>
      <pubDate>Tue, 30 Nov 2004 12:00:00 GMT</pubDate>
      <guid>http://www.fooblog.com/myreviews/blade.htm#blade_{—}
        trinity-tlr_480.mov</guid>
      <enclosure
        url=“http://movies.apple.com/movies/newline/blade_trinity/
        blade_trinity-tlr_480.mov” length=“3200000”
        type=“video/quicktime” />
      <media:movie title=“Blade: Trinity” cast=“Wesley Snipes, Kris
        Kristofferson, Ryan Reynolds, Jessica Biel, Parker Posey”
        year=“2004” contentType=“trailer” />
    </item>
  </channel>
</rss>
```

Module 145 of FIG. 1 illustrates one rendering of the sample code above. In one embodiment, an aggregator can show the user the title and cast of the movie in a popup window when the user places their mouse pointer over the module rendering the RSS feed. In one embodiment, the media RSS extensions can be used even if the item does not contain an enclosure or a media content link, e.g. a movie review blog.

Presented below is another example of an RSS feed with additional metadata, used to enhance the images found at an “actor fan club.”:

```
<?xml version=“1.0” ?>
- <rss version=“2.0” xmlns:media=
“http://docs.yahoo.com/mediaModule”>
  - <channel>
    <title>Mr. Incredible Paparazzi</title>
    <link>http://www.fooblog.com</link>
    <language>en-us</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <managingEditor>editor@example.com</managingEditor>
    <webMaster>webmaster@example.com</webMaster>
  - <item>
      <title />
      <link>http://www.fooblog.com/mrincredible.htm</link>
      <description>Our agent in the field caught a picture of
      Mr. Incredible
        filming his new reality television series, Superhero
        Lost</description>
      <pubDate>Tue, 30 Nov 2004 12:00:00 GMT</pubDate>
      <guid>http://www.fooblog.com/karaoke.html</guid>
      <enclosure
        url=“http://www.goodpictures.com/incredible101.jpg”
        length=“3200000” type=“image/jpeg” />
      <media:television title=“Superhero Lost” cast=“Mr. Incredible”
        director=“Mrs. Incredible” year=“2004”
        contentType=“extras” />
    </item>
  </channel>
</rss>
```

Module 150 of FIG. 1 illustrates one rendering of the sample code above. In one embodiment, a subscriber to this feed may only want images from the “Superhero Lost” show. Using the additional metadata, aggregators can now accommodate that desire.

In addition to descriptive information regarding the media file and the content of the media file. Legal information associating an intellectual property right with a media object can be used in conjunction with Media RSS. A known way to add a Creative Commons license to an RSS feed is described at http://backend.userland.com/creativeCommonsRssModule. Below is an example of a podcast RSS feed for “my latest song” that uses Creative Commons RSS extension to add a license to the work:

```
<?xml version=“1.0” ?>
<rss version=“2.0” xmlns:media=“http://docs.yahoo.com/mediaModule”
xmlns:creativeCommons=
“http://backend.userland.com/creativeCommonsRssModule”>
  - <channel>
    <title>Bored.net</title>
    <link>http://www.fooblog.com/Bored</link>
    <language>en</language>
    <pubDate>Tue, 30 Nov 2004 12:00:00 GMT</pubDate>
    <lastBuildDate>Tue, 30 Nov 2004 12:00:00 GMT</lastBuildDate>
    <docs>http://blogs.law.harvard.edu/tech/rss</docs>
    <generator>Notepad</generator>
    <ttl>180</ttl>
    <managingEditor>editor@example.com</managingEditor>
    <webMaster>webmaster@example.com</webMaster>
  - <item>
      <title>Bored.net Audioblog/Podcast #1</title>
      <link>http://www.fooblog.com/bored.htm</link>
      <pubDate>Tue, 01 Dec 2004 12:00:00 GMT</pubDate>
    <guid
        isPermaLink=“true”>http://www.fooblog.com/bored/2004/
        12/01#1</guid>
      <enclosure url=“http://www.foo.com/anthem.mp3”
        length=“3200000” type=“audio/mpeg” />
        <media:music artiste=“John” album=“Greatest Hits 2” song=“The
        Start Spangled Banner” year=“2004” contentType=“full” />
        <creativeCommons:license>http://www.creativecommons.org/
        licenses/by-nc/1.0</creativeCommons:license>
    </item>
  </channel>
</rss>
```

Module 205 of FIG. 2 illustrates one rendering of the sample code above. In one embodiment, an aggregator can append the letters “CC” to indicate the intellectual property right associated with the media object. In addition, in one embodiment, the Creative Commons element can be made into a subelement of the media <content> element. Thus, the Creative commons license is specifically applied to the media, instead of at a channel or item level. This technique can also be used to specify other types of associated intellectual property rights, and is useful when multiple media objects in the same <item> element have different rights associated with them.

<media:content url=“http://www.foo.com/anthem.mp3” length=“3200000”
type=“audio/mpeg”>
<creativeCommons:license>http://www.creativecommons.org/licenses/
by-nc/1.0</creativeCommons:license>
</media:content>

Enclosures work well for links to media content that can be downloaded and cached. Sometimes, one does not have access to an underlying file, or one does not want to make the underlying file available directly. In these cases, a Media <content> element, implemented in accordance with one embodiment of the invention, allows one to provide a player link instead of a direct link to a media object. In addition, information about the media embedded by the player can also be included. If the media object is a video, one can define a <keyframe> that can be used to represent the video. For example, the code below provides a link to a video player that plays the band's latest video and a keyframe to represent the video:

```
<?xml version=“1.0” ?>
  - <rss version=“2.0” xmlns:media=
  “http://docs.yahoo.com/mediaModule”
  xmlns:creativeCommons=“http://backend.userland.com/
  creativeCommonsRssModule”>
  - <channel>
      <title>John's Band Page</title>
      <link>http://www.fooblog.com</link>
      <language>en-us</language>
      <pubDate>Tue, 30 Nov 2004 12:00:00 GMT</pubDate>
      <lastBuildDate>Tue, 30 Nov 2004 12:00:00 GMT</lastBuildDate>
      <docs>http://blogs.law.harvard.edu/tech/rss</docs>
      <generator>Notepad</generator>
      <managingEditor>editor@example.com</managingEditor>
      <webMaster>webmaster@example.com</webMaster>
    - <item>
        <title>Bored.net Audioblog/Podcast #1</title>
        <link>http://www.fooblog.com/bored.htm</link>
        <pubDate>Tue, 01 Dec 2004 12:00:00 GMT</pubDate>
        <guid
          isPermaLink=“true”>http://www.fooblog.com/bored/2004/1
          2/01#1</guid>
      - <media:content>
          <media:playerLink url=“http://www.foo.com/cgi-
            bin/generate.pl?id=123456” />
          <media:contentInfo height=“200” width=“320”
          duration=“220”
            type=“video/mpeg” />
        </media:content>
          <media:keyframe>www.fooblog.com/img/anthem.jpg</
          media:keyframe>
        <media:music artist=“John” album=“Greatest Hits 2” song=“The
          Start Spangled Banner” year=“2004” contentType=“full” />
          <creativeCommons:license>http://www.creativecommons.org/
          licenses/by-nc/1.0</creativeCommons:license>
      </item>
  </channel>
</rss>
```

Module 210 of FIG. 2 illustrates one rendering of the sample code above. The keyframe image is displayed in the image/video section 211 of module 210. While the module 210 shows the media player embedded in the personalized homepage 200, other renderings of the RSS feed above may exclude the embedded media player and open the media in a separate media player program and/or browser window when the user selects the “music video” link 212.

For some publishers of video content, its common practice to provide multiple formats and multiple levels of quality for a piece of content. Therefore, in one embodiment, more then one media object can be added the <item> element above. Module 215 of FIG. 2 illustrates one rendering of an RSS feed with multiple formats and multiple levels of quality. As shown, the video is offered in “WMV” format in a high quality and a low quality, and the video is also offered in a “RM” format in a high quality and a low quality. Additionally, in one embodiment, the RSS feed can specify one of the media object choices as a default object. In one embodiment, the aggregator or the browser can determine which media object versions are most suitable for a user's computer and only render those objects.

In one embodiment of the invention, Media RSS can be used to preview a news article and provide access to media associated with article. Module 220 of FIG. 2 illustrates one rendering of an RSS feed from a news organization. The feed comprises three items, the first item is titled “Breaking News” and comprises an accompanying image 221, a space for a short description or excerpt of the article and three related media objects. The first object is a photo related to the news story, the second object is a video, for example a live video feed from the scene of the incident, and the third object is an audio podcast that can comprise, for example, the latest updates or commentary from the author. The video object also comprises a popup or drop down menu 222, which a user can use to select the quality of the video.

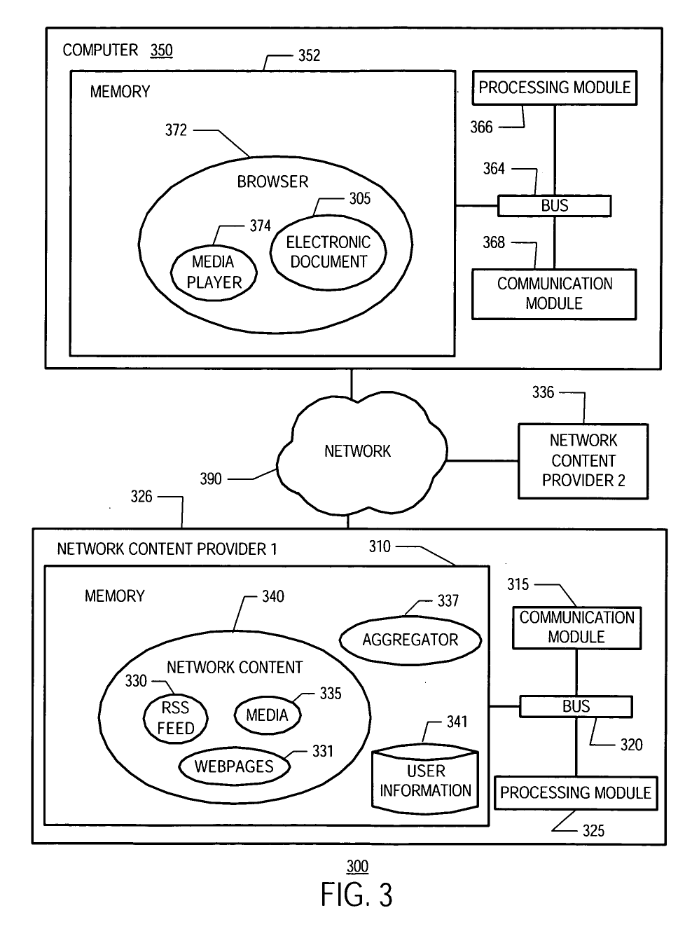

FIG. 3 illustrates a block diagram of a system 300 implemented in accordance with one embodiment of the invention. System 300 comprises a computer 350, a network content provider one 326, and a network content provider two 336, each coupled to a network 390, such as, for example, the Internet 390. A network user can use computer 350 to access content and/or services, such as, for example, RSS feeds, from providers 326 and 336 through the network 390.

Computer 350 comprises a processing module 366, a communication module 368 and memory 352 coupled together by bus 364. The modules of computer 350 can be implemented as any combination of hardware, software, hardware emulating software and reprogrammable hardware. The bus 364 is an exemplary bus illustrating the interoperability of the different modules of the computer 350. In different embodiments, there may be more than one bus and in other embodiments, some modules can be directly coupled instead of coupled to a bus 364. In alternate embodiments, computer 350 may be a desktop, a notebook computer, a Personal Digital Assistant (PDA), a handheld device, a wireless phone or any other device known or hereafter developed that is capable of performing functions as described herein.

The processing module 366 can be implemented as, in an exemplary embodiment, one or more Central Processing Units (CPUs), Field-Programmable Gate Arrays (FPGA), or any other component capable of executing computer applications. Communication module 368 comprises one or more I/O components used by the computer 350 to communicate with users and other devices. For example, components such as, a monitor, a keyboard, a mouse and a disk drive, can be used by a user to input and output information from the computer 350.

In addition, the communication module 368 facilitates two way communication between the computer and other electronic devices or systems, such as, for example, server computers provided by a network content provider one 326 and/or two 336. Components such as a modem, a network interface card (NIC), a wireless adapter, a Universal Serial Bus (BUS) adapter, etc., can be used by the computer 350 to communicate with the network 390, and/or with peripheral devices. The computer 350 may be communicatively connected to the network 390 through the communication module 368, for example, over one or more transmission media including but not limited to coaxial cable, copper wires and fiber optic cables. Communication between the computer 350 and the network 390 may also be accomplished wirelessly.

Memory 352 can be implemented as volatile memory, non-volatile memory, rewriteable memory, etc., such as, for example, Random Access Memory (RAM), Read Only Memory (ROM) and/or flash memory. Memory 352 is illustrated as a single module in FIG. 3, but in some embodiments, memory 352 can comprise more than one memory module and some memory 352 can be part of other modules of computer 350, such as, for example, processing module 366.

In the embodiment illustrated in FIG. 3, memory 352 has stored thereon a browser 372, a media player 374 and an electronic document 305. A network user using computer 350 may gain access to content on the network 390 by using a browser 372. For example, a network user browsing the Internet 390 can use Universal Resource Identifiers (URIs), such as, for example, Uniform Resource Locators (URLs), to locate and communicate with network content/service providers. In one embodiment of the invention, connection to the network 390 is provided through an Internet Service Provider (ISP). The media player 374 can be, in one embodiment, a plugin to the browser 372 and can play media objects retrieved from the Internet 390. In one embodiment, the media player 374 can be an application that is separate from the browser 372, which is called by the browser 372 when a media object is executed.

Electronic documents 305 can comprise a plurality of elements, such as, for example, Hypertext Markup Language (HTML), Extensible Markup Language (XML), electronic images, Portable Document Files (PDFs), flash files, etc. On the Internet, an electronic document can be a webpage and/or an RSS feed. Network content provider 336 can also have stored thereon, plug-ins, that can be downloaded onto the computer 350 and add functionality to the browser 372. Examples of plug-ins are downloadable network toolbars, media players, etc.

Network content provider 326 comprises communication module 315, processing module 325 and memory 310 coupled together by bus 320. Network content provider 336 and network content provider 326 can be implemented as computers, such as, for example, servers, connected to the network 390. Communication module 315, processing module 325, memory 310 and bus 320 can be implemented with components that are similar to the like named components of computer 350. The memory 310 of network content provider 326 has stored thereon, network content 340 and an RSS aggregator 337.

Network content provider one 326 can offer a plurality of web content and services, for example, network content 340 can comprise webpages 331, RSS feeds 330 and media 335, which can be downloaded by Internet users. The network content provider one 326 can also provide personalized homepages that can aggregate an Internet user's RSS feeds. The aggregator 337 determines an Internet user's subscribed feeds from user information 341, and retrieves the feeds from a local computer and/or from a network. The aggregator renders the retrieved feeds onto a personalized homepage and sends the personalized homepage to the Internet user.

The placement of the modules 372, 374, 305, 340, 330, 331, 335, 337, 341 in FIG. 3 illustrate one embodiment of the invention. In alternate embodiments, the network content 340, user information 341 and the aggregator 337 can be located in a plurality of computers in a plurality of combinations across the network 390. In one embodiment, the aggregator 337 can be located in the user computer and can present a user's feeds in a program separate from the browser 372.

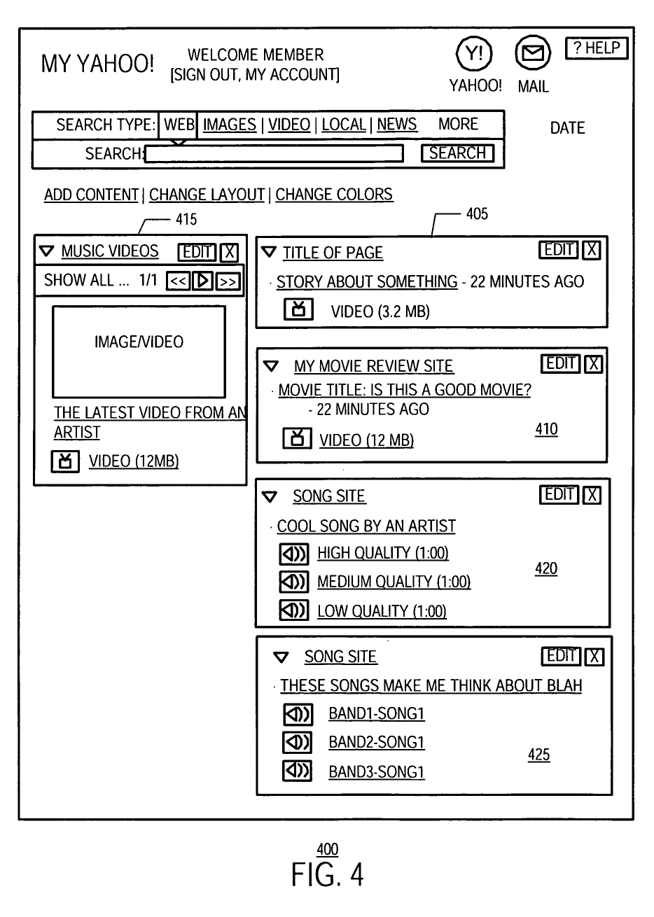

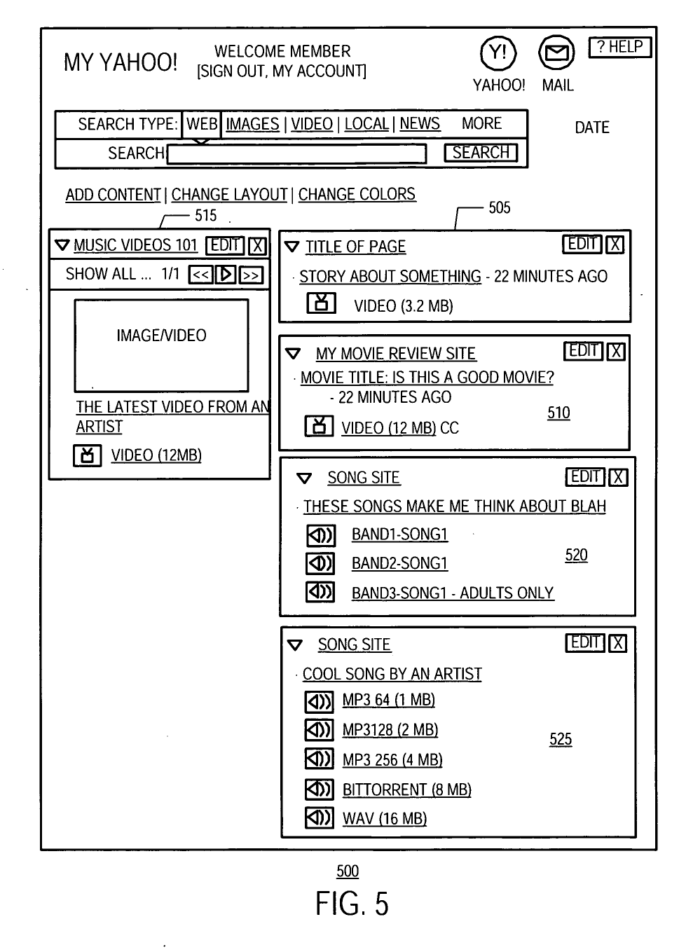

A specification for a Media RSS module implemented in accordance with one embodiment of the invention is now described with reference to FIG. 4. The namespace declaration for the module is xmlns:media=“http://docs.yahoo.com/mediaModule/”. The module comprises six elements, one primary element, <media:content>, and five optional elements, <media:keyframe>, <media:category>, <media:people>, <media:person> and <media:text>.

<media:content> is a subelement of <item>, which contains 8 attributes, all of which are optional. The <media:content> element identifies a media object and provides access to the object, for example, through a direct link and/or through a media player. Each <item> element can comprise a plurality of <media:content> subelements. Below is an example of a <media:content> element:

```
<media:content url=“http://www.foo.com/movie.mov” length=
“12216320” type=“audio/mpeg”
  playerUrl=“http://www.foo.com/player?id=11” playerHeight=“200”
  playerWidth=“400”
  isDefault=“true”
  expression=“sample|full”
</media:content>
```

Attribute url, specifies the direct URL to the media object. If a URL is not included, a playerUrl must be specified. Attribute length, is the number of bytes of the media object. Attribute type is the standard MIME type of the object. AttributeplayerUrl is the url of a media player console. PlayerUrl can be used to limit a subscriber's direct access to a media file. Attribute playerHeight is the height of the window that the playerUrl should be opened in. Attribute playerWidth is the width of the window that the playerUrl should be opened in. Attribute is Default determines which media object is the default object for an <item> element. Attribute expression determines if the object is a sample or the full version of the object.

The following elements are optional and can either be a sub-element of <item>, <enclosure>, or <media:content>. When used as a sub-element of <item>, it means that the element is applied to every media object in the <item>. When used as a sub-element of <media:content>, it only applies to that particular media object.

The <media:keyframe> element allows a particular image to be used as the representative image for the media object. An example is shown below:

<media:keyframe>http://www.foo.com/keyframe jpg</media:keyframe>

The <media:category> element allows a taxonomy to be set that gives an indication of the type of media content, and its particular contents. The taxonomy can be used by an aggregator and/or a search engine to categorize the media in an RSS feed and present targeted results to a user. An example is shown below:

<media:category>music/artist name/album/song</media:category>
<media:category>television/series/episode/episode number</
media:category>

The <media:people> element lists the notable entities, for example, people and/or businesses, who contributed to the creation of the media object. An example is shown below:

<media:people> important people associated with work</media:people>

The <media:person> element can be used as an alternative to the <media:people> element. <media:person> breaks down the contribution to an individual level. <media:person> has one attribute: role. The role can be producer, artist, news anchor, cast member, and the like. An example is shown below:

<media:person role=“producer”>person's name</media:person>

The <media:text> element allows the inclusion of a text transcript/close captioning/lyrics of the media content. An example is shown below:

<media:text>Oh, say, can you see, by the dawn's early light, . . . </media:text>

The following examples illustrate the use of the elements described above. FIG. 4 illustrates one rendering of the examples in a personalized home page 400. Below is an example of a known RSS document that uses the <enclosure> element, without any of the special media extensions. Module 405 of FIG. 4 illustrates one rendering of the sample code.

```
<rss version=“2.0”>
<channel>
  <title>Title of page</title>
  <link>http://www.foo.com</link>
  <description>Description of page</description>
  ...
  <item>
    <title>Story about something</title>
    <link>http://www.foo.com/item1.htm</link>
    ...
    <enclosure url=“http://www.foo.com/file.mov” length=“320000”
    type=“video/quicktime” />
  </item>
</channel>
</rss>
```

Below is an example of an RSS document for a movie review associated with a trailer. This example shows how Media RSS can be used to associate a media object with an <item> instead of the <enclosure> element. Module 410 of FIG. 4 illustrates one rendering of the sample code.

```
<rss version=“2.0” xmlns:media=“http://docs.yahoo.com/mediaModule”>
<channel>
  <title>My Movie Review Site</title>
  <link>http://www.foo.com</link>
  <description>I review movies.</description>
  ...
  <item>
    <title>Movie Title: Is this a good movie?</title>
    <link>http://www.foo.com/item1.htm</link>
    ...
    <media:content url=“http://www.foo.com/trailer.mov”
length=“12216320” type=“video/quicktime”
          expression=“sample|full”>
    </media:content>
  </item>
</channel>
</rss>
```

Below is an example of an RSS document for a music video played through a media player. The document also comprises additional metadata related to the music video. As mentioned above the additional information can be used to, for example, sort the video and offer improved searches. Module 415 of FIG. 4 illustrates one rendering of the sample code. In one embodiment, the additional information can be displayed to a user in a popup menu, when the user positions their mouse pointer over module 415.

```
<rss version=“2.0” xmlns:media=“http://docs.yahoo.com/mediaModule”>
<channel>
  <title>Music Videos 101</title>
  <link>http://www.foo.com</link>
  <description>Discussions of great videos</description>
  ...
  <item>
    <title>The latest video from an artist</title>
    <link>http://www.foo.com/item1.htm</link>
    ...
    <media:content url=“http://www.foo.com/movie.mov”
          length=“12216320” type=“video/quicktime”
          playerUrl=“http://www.foo.com/player?id=1111”
          playerHeight=“200” playerWidth=“400”
          expression=“full”>
  </media:content>
  <media:person role=“producer”>producer's name</media:person>
  <media:person role=“artist”>artist's name</media:person>
  <media:category>music/artist name/album/song</media:category>
  <media:text>Oh, say, can you see, by the dawn's early light,...</
  media:text>
  </item>
</channel>
</rss>
```

Below is an example of an RSS document comprising a song for syndication. In this example, a single <item> element comprises the same song at different bitrates to accommodate the bandwidth and/or preference of different subscribers. The document also comprises additional information, for example, band members and the song's taxonomy. Using the song's taxonomy, a user can easily sort through the songs that interest them. Module 420 of FIG. 4 illustrates one rendering of the sample code.

```
<rss version=“2.0” xmlns:media=“http://docs.yahoo.com/mediaModule”>
<channel>
  <title>Song Site</title>
  <link>http://www.foo.com</link>
  <description>Songs galore at different bitrates</description>
  ...
  <item>
    <title>Cool song by an artist</title>
    <link>http://www.foo.com/item1.htm</link>
    ...
    <media:content url=“http://www.foo.com/song64kbps.mp3”
          length=“1000” type=“audio/mpeg”
          isDefault=“true”
          expression=“full”>
    </media:content>
    <media:content url=“http://www.foo.com/song128kbps.mp3”
          length=“2000” type=“audio/mpeg”
          expression=“full”>
    </media:content>
    <media:content url=“http://www.foo.com/song256kbps.mp3”
          length=“4000” type=“audio/mpeg”
          expression=“full”>
    </media:content>
    <media:people>members of band</media:people>
    <media:category>music/artist name/album/song</media:category>
  </item>
</channel>
</rss>
```

Below is an example of an RSS document for several different songs that are related to the same topic. The <media:content> element is not limited to grouping the same song in different quality levels. An <item> element can also use Media RSS to group related media objects. For example, in the sample code below a music listener groups songs that make them feel a certain way. Module 425 of FIG. 4 illustrates one rendering of the sample code.

```
<rss version=“2.0” xmlns:media=“http://docs.yahoo.com/mediaModule”>
<channel>
  <title>Song Site</title>
  <link>http://www.foo.com</link>
  <description>Discussion on different songs</description>
  ...
  <item>
    <title>These songs make me think about blah</title>
    <link>http://www.foo.com/item1.htm</link>
    ...
    <media:content url=“http://www.foo.com/band1-song1.mp3”
          length=“1000” type=“audio/mpeg”
          expression=“full”>
      <media:people>members of band1</media:people>
      <media:category>music/band1/album/song</media:category>
    </media:content>
    <media:content url=“http://www.foo.com/band2-song1.mp3”
          length=“2000” type=“audio/mpeg”
          expression=“full”>
      <media:people>members of band2</media:people>
      <media:category>music/band2/album/song</media:category>
    </media:content>
    <media:content url=“http://www.foo.com/band3-song1.mp3”
length=“4000” type=“audio/mpeg”
          expression=“full”>
      <media:people>members of band3</media:people>
      <media:category>music/band3/album/song</media:category>
    </media:content>
  </item>
</channel>
</rss>
```

Another specification for a Media RSS module implemented in accordance with one embodiment of the invention is now described with reference to FIG. 5. The namespace declaration for the module is <rss version=“2.0” xmlns:media=“http://search.yahoo.com/mrss/”>. The module comprises six elements, two primary elements, <media:content> and <media:group>, and thirteen optional elements, <media:adult>, <media:rating>, <media:title>, <media:description>, <media:keywords>, <media:thumbnail>, <media:category>, <media:hash>, <media:player>, <media:credit>, <media:copyright>, <media:text> and <media:restriction>.

The <media:content> element is a sub-element of either <item> or <media:group>. The <media:content> element is used to publish any type of media object. The sequence of these elements implies the order of presentation when an RSS document is rendered. <media:content> comprises fourteen optional attributes. While many of the attributes appear to be audio/video specific, this element can be used to publish any type of media. Below is an example of a <media:content> element:

```
<media:content
    url=“http://www.foo.com/movie.mov”
    fileSize=“12216320”
    type=“video/quicktime”
    medium=“video”
    isDefault=“true”
    expression=“full”
    bitrate=“128”
    framerate=“25”
    samplingrate=“44.1”
    channels=“2”
    duration=“185”
    height=“200”
    width=“300”
    lang=“en” />
```

The url attribute specifies the direct URL to the media object. If a url attribute is not included, a <media:player> element must be specified.

The fileSize attribute specifies the number of bytes in the media object.

The type attribute is the standard MIME type of the object. It is an optional attribute.

The medium attribute is the type of the object, for example, image, audio, video, document, executable, and other media objects. While this attribute can at times seem redundant if type is supplied, it is included because it simplifies decision making on the reader side, as well as flushes out any ambiguities between MIME type and object type.

The is Default attribute determines if the media object identified by the <media:content> element is the default object that should be used for the <item> or <media:group>. There should only be one default object per <media:group>. The <media:group> element is described below.

The expression attribute determines if the object is a sample (sample), the full version of the object (full), or if it is a continuous stream (nonstop). The default value is ‘full’.

The bitrate attribute is the kilobits per second rate of media object.

The framerate attribute is the number of frames per second for the media object.

The samplingrate attribute is the number of samples per second taken to create the media object. It is expressed in thousands of samples per second (kHz).

The channels attribute is the number of audio channels in the media object.

The duration attribute is the number of seconds the media object plays.

The height attribute is the height of the media object.

The width attribute is the width of the media object.

The lang attribute is the primary language encapsulated in the media object. Values for the lang attribute are detailed in RFC 3066. For example, “en” stands for English.

The <media:group> element is an optional sub-element of <item>. It allows grouping of <media:content> elements that are effectively the same content, yet different representations. For example, a same song recorded in a WAV format and an MP3 format can be placed in the same group.

The following elements are optional and may appear as sub-elements of <channel>, <item>, <media:content> and/or <media:group>. When an element appears at a shallow level, such as <channel> or <item>, it means that the element is applied to every media object within its scope. Duplicated elements appearing at deeper levels of the document tree have higher priority over other levels. For example, <media:content> level elements are favored over <item> level elements. The priority level is listed from strongest to weakest: <media:content>, <media:group>, <item>, <channel>.

The <media:adult> element indicates that the media object contains media for adults only. The function of this element can also be accomplished using <media:rating>.

The <media:rating> element declares the permissible audience for a media object. If this element is not included, it assumes that no restrictions are necessary. An example is shown below:

<media:rating scheme=“urn:simple”>adult</media:rating>
<media:rating scheme=“urn:icra”>r (cz 1 lz 1 nz 1 oz 1 vz
1)</media:rating>
<media:rating scheme=“urn:mpaa”>pg</media:rating>
<media:rating scheme=“urn:v-chip”>tv-y7-fv</media:rating>

The scheme attribute identifies the rating scheme used. For example, the movie rating scheme or the television rating scheme can be used. If this attribute is not included, the default rating is either adult or nonadult.

The <media:title> element specifies the title of the particular media object. It has one optional attribute. An example is shown below:

<media:title type=“plain”> The Judy's—The Moo Song</media:title>

The optional type attribute specifies the type of text embedded. Possible values for the type attribute are either ‘plain’ or ‘html’. The default value is ‘plain’. All html must be entity-encoded.

The <media:description> element can be used to provide a description of the media object. It is typically a sentence in length, and can also comprise an optional type attribute. An example is shown below:

<media:description type=“plain”>This was some really bizarre band I listened to as a young lad.</media:description>

The <media:keywords> element can be used to include relevant keywords describing the media object. In this embodiment, there is a maximum limit of ten words and the keywords and phrases are comma delimited. An example is shown below:

<media:keywords>kitty, cat, big dog, yarn, fluffy</media:keywords>

The <media:thumbnail> element allows particular images to be used as representative images for the media object. If multiple thumbnails are included, and time coding is not at play, it is assumed that the images are in order of importance. The <media:thumbnail> element has 1 required attribute and 3 optional attributes. An example is shown below:

<media:thumbnail url=“http://www.foo.com/keyframe.jpg” width=“75” height=“50” time=“12:05:01.123”/>

The url attribute, which is a required attribute, specifies the URL of the thumbnail. The optional height and width attributes specifies the height and width of the thumbnail. The optional time attribute specifies a time offset in relation to the media object. Therefore, a preview of a video object displays a frame in the middle of the object instead of the first frame. Typically this is used when creating multiple keyframes within a single video. The format for this attribute can be in the DSM-CC's Normal Play Time (NPT) as used in RTSP [RFC 2326 3.6 Normal Play Time].

NPT has a second or subsecond resolution. It is specified as H:M:S.h (npt-hhmmss) or S.h (npt-sec), where H=hours, M=minutes, S=second and h=fractions of a second. An alternative to NPT would be the Society of Motion Picture and Television Engineers (SMPTE) timecode.

The <media:category> element allows a taxonomy to be given to a media object to associate a category to the media object, and its particular contents. <media:category> has 2 optional attributes. Three examples are shown below:

<media:category scheme=“http://search.yahoo.com/mrss/category_{—}
schema”>music/artist/album/song</media:category>
<media:category scheme=“http://dmoz.org” label=“Ace Ventura - Pet
Detective”>Arts/Movies/Titles/A/Ace_Ventura_Series/Ace_Ventura_{—}
-_Pet_Detective</media:category>
<media:category scheme=“urn:flickr:tags”>ycantpark
mobile</media:category>

The optional scheme attribute specifies a URI that identifies the categorization scheme. If this attribute is not included, a default scheme is located at ‘http://search.yahoo.com/mrss/category_schema’. The optional label attribute is the human readable label that can be displayed in end user applications.

The <media:hash> element is a hash of the binary media file. It can appear multiple times as long as each instance is created by a different algorithm. The <media:hash> element has 1 optional attribute. An example is shown below:

<media:hash algo=“md5”>dfdec888b72151965a34b4b59031290a</media:hash>

The optional algo attribute indicates the algorithm used to create the hash. Possible values include ‘md5’ and ‘sha-1’. A default value is ‘md5’.

The <media:player> element allows the media object to be accessed through a web browser media player console. This element is required only if a direct media url attribute is not specified in the <media:content> element. The <media:player> element has 1 required attribute, and 2 optional attributes. An example is shown below:

<media:player url=“http://www.foo.com/player?id=1111” height=“200” width=“400”/>

The required url attribute is the URL of the player console that plays the media. The optional height and width attributes specify the height and width of the browser window that the url should be opened in.

The <media:credit> element specifies notable entities and their contribution to the creation of the media object. Current entities can include people, companies, locations, etc. Specific entities can have multiple roles, and several entities can have the same role. An example is shown below:

<media:credit role=“producer” scheme=“urn:ebu”>entity name</media:credit>

The optional role attribute specifies the role the entity played. The optional scheme attribute identifies the scheme used to identify the roles. If this attribute is not included, the default scheme is the European Broadcasting Union Role Codes (urn:ebu). Example role comprise actor, anchor person, author, choreographer, composer, conductor, director, editor, graphic designer, grip, illustrator, lyricist, music arranger, music group, musician, orchestra, performer, photographer, producer, reporter and vocalist.

The <media:copyright> element can be used to specify the copyrights associated with the media object. An example is shown below:

<media:copyright url=“http://blah.com/additional-info.html”>2005
FooBar Media</media:copyright>

The optional url attribute can be used to specify a URL pointing to a webpage comprising the terms of use or additional copyright information. If the media is operating under a Creative Commons license, the Creative Commons module can be used.

The <media:text> element allows the inclusion of a text transcript, closed captioning, or lyrics of the media content. The timing of when certain text is relevant to the media object can be included in the element as an optional attribute. An example is shown below:

<media:text type=“plain” lang=“en” start=“00:00:03.000”
end=“00:00:10.000”> Oh, say, can you see</media:text>
<media:text type=“plain” lang=“en” start=“00:00:10.000”
end=“00:00:17.000”>By the dawn's early light</media:text>

The optional type attribute specifies the type of text embedded. The optional lang attribute specifies the primary language encapsulated in the media object. The optional start and end attributes specify the start time offset that the text starts being relevant to the media object and the end time when the text is no longer relevant. Start and end time can be used for closed captioning. <media:text> elements can have overlapping start and end times.

The <media:restriction> element allows restrictions to be placed on the aggregator rendering the media in the feed. Currently, restrictions are based on distributor and country codes. This element is purely informational and no obligation can be assumed or implied. Only one <media:restriction> element of the same type can be applied to a media object, all others are ignored. Entities in this element should be space separated. To allow the producer to explicitly declare his/her intentions, two literals are reserved: ‘all’, ‘none’. These literals can only be used once. An example is shown below:

<media:restriction relationship=“allow” type=“country”>au us</media:restriction>

The required relationship attribute indicates the type of relationship that the restriction represents. The value of the relationship attribute include allow and deny. In the example above, the media object should only be syndicated in Australia and the United States. If the “allow” element is empty and the type is relationship is “allow”, it is assumed that the empty list means “allow nobody” and the media should not be syndicated.

The optional type attribute specifies the type of restriction that is identified in the element. For example, the type can identify restricted countries or restricted URIs. If the value of type is “country”, the <media:restriction> element includes a country where the media should not be syndicated. If the value of type is “uri”, the <media:restriction> element includes a uri where the media should not be syndicated.

The following examples illustrate the use of the elements described above. Below is an example of an RSS document for a recently created movie using the <enclosure> element and without using Media RSS. Module 505 of FIG. 5 illustrates one rendering of the sample code.

```
<rss version=“2.0”>
<channel>
<title>Title of page</title>
<link>http://www.foo.com</link>
<description>Description of page</description>
    <item>
          <title>Story about something</title>
          <link>http://www.foo.com/item1.htm</link>
          <enclosure url=“http://www.foo.com/file.mov”
          length=“320000” type=“video/quicktime”/>
    </item>
</channel>
</rss>
```

Below is an example of an RSS document that uses the elements described above in conjunction with a Creative Commons license. Module 510 of FIG. 5 illustrates one rendering of the sample code.

```
<rss version=“2.0”>
<channel>
<title>My Movie Review Site</title>
<link>http://www.foo.com</link>
<description>I review movies.</description>
    <item>
          <title>Movie Title: Is this a good movie?</title>
          <link>http://www.foo.com/item1.htm</link>
          <media:content url=“http://www.foo.com/trailer.mov”
          fileSize=“12216320” type=“video/quicktime”
          expression=“sample”/>
          <creativeCommons:license>
          http://www.creativecommons.org/licenses/by-nc/1.0
          </creativeCommons:license>
          <media:rating>nonadult</media:rating>
    </item>
</channel>
</rss>
```

Below is an example of an RSS document that syndicates a music video through a link to a player window. In addition, the same code includes additional metadata about the video. Module 515 of FIG. 5 illustrates one rendering of the sample code. Some or all of the metadata can be used by the aggregator to tailor the rendering of the document to a specific user's specifications. In addition, some or all of the metadata can be presented to the user in an additional window when the user positions their mouse pointer over the rendered module 515.

```
<rss version=“2.0”>
<channel>
<title>Music Videos 101</title>
<link>http://www.foo.com</link>
<description>Discussions of great videos</description>
    <item>
          <title>The latest video from an artist</title>
          <link>http://www.foo.com/item1.htm</link>
          <media:content url=“http://www.foo.com/movie.mov”
          fileSize=“12216320”
          type=“video/quicktime” expression=“full”>
          <media:player url=“http://www.foo.com/player?id=1111”
          height=“200” width=“400”/>
          <media:hash algo=“md5”
          >dfdec888b72151965a34b4b59031290a</media:hash>
          <media:credit role=“producer”>producer's name</
          media:credit>
          <media:credit role=“artist”>artist's name</media:credit>
          <media:category scheme=“http://blah.com/scheme”>music/
          artist name/album/song</media:category>
          <media:text type=“plain”>
          Oh, say, can you see, by the dawn's early light
          </media:text>
          <media:rating>nonadult</media:rating>
          <dcterms:valid>
              start=2002-10-13T09:00+01:00;
              end=2002-10-17T17:00+01:00;
              scheme=W3C-DTF
          </dcterms:valid>
          </media:content>
    </item>
</channel>
</rss>
```

Below is an example of an RSS document that syndicates several different songs that relate to the same topic. Module 520 of FIG. 5 illustrates one rendering of the sample code. The adult rated song “band3-song1” is clearly marked for “adults only.”

```
<rss version=“2.0”>
<channel>
<title>Song Site</title>
<link>http://www.foo.com</link>
<description>Discussion on different songs</description>
    <item>
          <title>These songs make me think about blah</title>
          <link>http://www.foo.com/item1.htm</link>
          <media:content url=“http://www.foo.com/band1-song1.mp3”
          fileSize=“1000” type=“audio/mpeg” expression=“full”>
          <media:credit role=“musician”>member of band1</
          media:credit>
          <media:category>music/band1/album/song</media:category>
          <media:rating>nonadult</media:rating>
          </media:content>
          <media:content url=“http://www.foo.com/band2-song1.mp3”
          fileSize=“2000” type=“audio/mpeg” expression=“full”>
          <media:credit role=“musician”>member of band2</
          media:credit>
          <media:category>music/band2/album/song</media:category>
          <media:rating>nonadult</media:rating>
          </media:content>
          <media:content url=“http://www.foo.com/band3-song1.mp3”
          fileSize=“1500” type=“audio/mpeg” expression=“full”>
          <media:credit role=“musician”>member of band3</
          media:credit>
          <media:category>music/band3/album/song</media:category>
          <media:rating>adult</media:rating>
          </media:content>
    </item>
</channel>
</rss>
```

Below is an example of an RSS document that syndicates one song at different bitrates and encodings. Module 525 of FIG. 5 illustrates one rendering of the sample code.

```
<rss version=“2.0”>
<channel>
<title>Song Site</title>
<link>http://www.foo.com</link>
<description>Songs galore at different bitrates</description>
    <item>
        <title>Cool song by an artist</title>
        <link>http://www.foo.com/item1.htm</link>
        <media:group>
            <media:content url=“http://www.foo.com/song64kbps.mp3”
            fileSize=“1000” bitrate=“64” type=“audio/mpeg”
            isDefault=“true” expression=“full”/>
            <media:content url=“http://www.foo.com/
            song128kbps.mp3”
            fileSize=“2000” bitrate=“128” type=“audio/mpeg”
            expression=“full”/>
            <media:content url=“http://www.foo.com/
            song256kbps.mp3”
            fileSize=“4000” bitrate=“256” type=“audio/mpeg”
            expression=“full”/>
            <media:content url=“http://www.foo.com/
            song512kbps.mp3.torrent”
            fileSize=“8000” type=“application/
            x-bittorrent;enclosed=audio/mpeg”
            expression=“full”/>
            <media:content url=“http://www.foo.com/song.wav”
            fileSize=“16000” type=“audio/x-wav” expression=“full”/>
            <media:credit role=“musician”>band member 1</
            media:credit>
            <media:credit role=“musician”>band member 2</
            media:credit>
            <media:category>music/artist name/album/song</
            media:category>
            <media:rating>nonadult</media:rating>
        </media:group>
    </item>
</channel>
</rss>
```

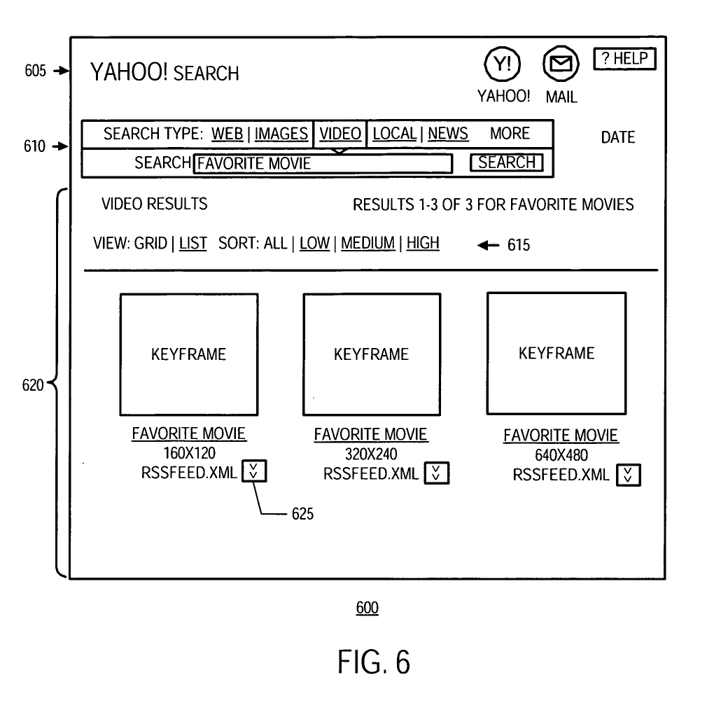

FIG. 6 illustrates an video web search results page 600 implemented in accordance with one embodiment of the invention. The search results page 600 comprises a title section 605, a search section 610, a view options section 615 and a content display area 620. An Internet user can search the web for videos by selecting the video button in the search section 610 and typing a search term into the field in the search section 610. The results of the search are displayed in the content display area 620.

Using the additional metadata provided by Media RSS, a search engine can find and present to an Internet user multiple versions of the same movie. The different versions can be the same video in different quality settings, expressions and/or encoding schemes. An Internet user can use view options 615 to change the view of the search results and to sort the search results. Search results page 600, gives the user the option to view all results, low quality video, medium quality video and high quality video. In one embodiment, the search results can be sorted based on any of the additional metadata related to the media object and the content of the media object.

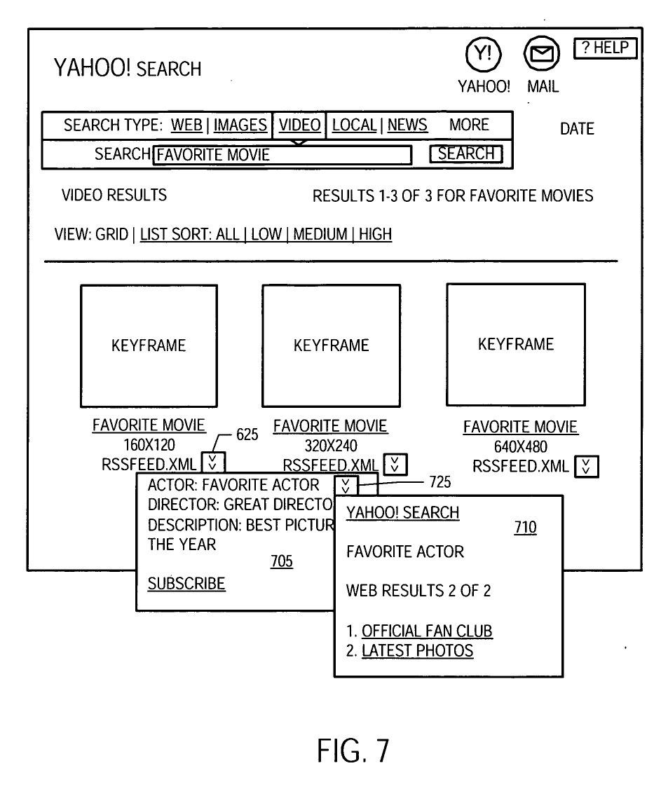

The search results in search results page 600, also comprises a button 625, which can be used to provide additional information to a user. FIG. 7 illustrates one embodiment of additional drop down windows 705, 710 that provide additional information to a user. When a user selects button 625, window 705 appears including additional information from the RSS feed. In addition, window 705 provides a link to subscribe to the feed. The window 705 also comprises an additional information button 725 next to the actor. When button 725 is selected, window 710, which comprises the results of a search on the actor, is displayed.

It will be recognized that while the features and functions described above are described in relation to network components and user side components, such features and functions can be implemented at any point in the network, on single or multiple computers and/or servers, and network functions can also be duplicated at the user computer for functioning independent of the network if desired. Thus user side changes and or network side changes can be synchronized and or synchronized when a user returns to the network in manners known in the art or hereafter to become known.

While the description of the various embodiments of the invention are described in a server/client network environment, alternate embodiments of the invention can be performed in a peer-to-peer network or other interconnectivity schemes now known or hereafter to become known.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. An electronic document comprising:
a first element written in a computer language, the language comprising a real simple syndication syntax, the element identifying a media object; and
a second element, written in the computer language and parsable by a real simple syndication aggregator, the second element comprising,
descriptive information, the descriptive information being related to the media object's content, and
a predefined tag that identifies a predefined type of the descriptive information.

2. The electronic document of claim 1, wherein the second element further comprises legal information that sets forth an intellectual property right associated with the media object.

3. The electronic document of claim 1, wherein the descriptive information comprises a keyword that describes the media object's content.

4. The electronic document of claim 1, wherein the descriptive information identifies an image that describes the media object.

5. The electronic document of claim 1, wherein the descriptive information is a universal resource identifier that identifies an image associated with the media object.

6. The electronic document of claim 1, wherein the descriptive information comprises a taxonomy of the media object, wherein the taxonomy of the media object is used to categorize the media object.

7. The electronic document of claim 1, wherein the descriptive information comprises at least one entity that contributed to the creation of the media object.

8. The electronic document of claim 1, wherein the descriptive information comprises a text transcript of the words embodied in the media object.

9. The electronic document of claim 1, wherein the descriptive information comprises a bitrate.

10. The electronic document of claim 1, wherein the descriptive information comprises information identifying any one or more than one of an actor's role, a title, a cast, an artist, a director, a producer, a studio, a publisher, an album or a year associated with the media object.

11. The electronic document of claim 1, wherein the first element identifies the media object via a universal resource identifier.

12. The electronic document of claim 1, wherein the second element identifies the media object via a universal resource identifier.

13. The electronic document of claim 1, further comprising a namespace declaration.

14. The electronic document of claim 1, wherein the tag has a syntax comprising a less than symbol, a namespace, a colon, the predefined type and a greater than symbol.

15. The electronic document of claim 14, wherein the tag comprises the following syntax <media:content>.

16. The electronic document of claim 14, wherein the tag comprises the following syntax <media:category>.

17. The electronic document of claim 14, wherein the tag further comprises an attribute.

18. The electronic document of claim 1, wherein the second element is a sub-element of the first element.

19. The electronic document of claim 1, wherein the first element is an enclosure element.

20. The electronic document of claim 1, wherein at least one of the first element and the second element further comprises at least one attribute, the attribute comprising the descriptive information.

21. A computer application, comprising computer code defining at least one routine, the at least one routine being operable to render an electronic document, the electronic document comprising:
a first element written in a computer language, the language comprising a real simple syndication syntax, the element identifying a media object; and
a second element, written in the computer language and parsable by a real simple syndication aggregator, the second element comprising,
descriptive information, the descriptive information being related to the media object's content, and
a predefined tag that identifies a predefined type of the descriptive information.

22. The computer application of claim 21, wherein the second element further comprises legal information that sets forth an intellectual property right associated with the media object.

23. The computer application of claim 21, wherein the computer application is a real simple syndication aggregator.

24. The computer application of claim 21, wherein the computer application is a browser.

25. The computer application of claim 21, wherein if a pointer is positioned over a rendered element, the computer application renders an additional user perceptible object.

26. The computer application of claim 25, wherein the additional user perceptible object is a window overlaid over the rendered element, the window comprising the descriptive information.

27. The computer application of claim 21, wherein the computer application is an extension to a second computer application.

28. The computer application of claim 27, wherein the extension is a media player plugin.

29. A system for syndicating media comprising:
a syndicating computer, the syndicating computer being operable to transmit to a user computer an electronic document comprising,
a first element written in a computer language, the language comprising a real simple syndication syntax, the element identifying a media object; and
a second element, written in the computer language and parsable by a real simple syndication aggregator, the second element comprising,
descriptive information, the descriptive information being related to the media object's content, and
a predefined tag that identifies a predefined type of the descriptive information.

30. The system of claim 29, wherein the second element further comprises legal information that sets forth an intellectual property right associated with the media object.

31. A method of syndicating media comprising:
transmitting an electronic document to a computer, the electronic document comprising,
a first element written in a computer language, the language comprising a real simple syndication syntax, the element identifying a media object; and
a second element, written in the computer language and parsable by a real simple syndication aggregator, the second element comprising,
descriptive information, the descriptive information being related to the media object's content, and
a predefined tag that identifies a predefined type of the descriptive information.

32. The method of claim 31, wherein the second element further comprises legal information that sets forth an intellectual property right associated with the media object.

33. The method of claim 32, wherein the first element identifies the media object via a universal resource identifier, and wherein the universal resource identifier further identifies a media player, the media player being operable to render the media object into a user perceptible form, the method further comprising:
receiving at least some part of the universal resource identifier; and
transmitting the media object to the media player.

34. A method of searching media comprising:
searching descriptive information within an electronic document comprising,
a first element written in a computer language, the language comprising a real simple syndication syntax, the element identifying a media object; and
a second element, written in the computer language and parsable by a real simple syndication aggregator, the second element comprising,
descriptive information, the descriptive information being related to the media object's content, and
a predefined tag that identifies a predefined type of the descriptive information.

35. The method of claim 34, wherein the second element further comprises legal information that sets forth an intellectual property right associated with the media object.

36. The method of claim 34, further comprising:
receiving a search request from a user, the search request comprising a search term;
searching a database of electronic documents; and
returning at least one search result to the user.

37. The method of claim 36, wherein the at least one search result identifies a media object associated with a real simple syndication document.

38. The method of claim 36, wherein search results are sorted based on the descriptive information.
